(19) United States
(12) Patent Application Publication
(10) Pub. No.: US 2026/0057256 A1
(43) Pub. Date: Feb. 26, 2026

(54) METHOD AND SYSTEM OF DYNAMIC PROMPT ORCHESTRATION

(71) Applicant: Accenture Global Solutions Limited, Dublin (IE)

(72) Inventors: Prakash GHATAGE, Bangalore (IN); Nirav Jagdish SAMPAT, Mumbai (IN); Naveen Kumar KUMAR THANGARAJ, Bangalore (IN); Sreenivasa Sekhar JOSYULA, Bangalore (IN); Ullas Balan NAMBIAR, Bangalore (IN); Priyalatha Padmini SASHIKUMAR, Bangalore (IN)

(21) Appl. No.: 18/815,025

(22) Filed: Aug. 26, 2024

(51) Int. Cl. G06N 5/022

(52) U.S. Cl. CPC G06N 5/022

(57) ABSTRACT

The present disclosure discloses a method and a system of dynamic prompt orchestration. The method includes maintaining a prompt library of artificial intelligence (AI) prompt categories. An inquiry is received and one of the prompt categories appropriate for advancing the received inquiry is selected. Further, based on the selected one of the prompt categories, an AI model from the model registry is selected. Thereafter, based on the selected AI model, a particular individual prompt from the selected one of the prompt categories is selected. The selected particular individual prompt is submitted to the selected AI model. The selected AI model provides information identifying how to respond to the inquiry, wherein the information including at least one action and data supporting the at least one action. Subsequently, the at least one action based on the data is executed and a response is generated.

### FIELD OF THE INVENTION

Various embodiments described herein relate generally to dynamic prompt orchestration. Specifically, a method and system of dynamic prompt orchestration is disclosed for providing context-driven adaptive user interaction using generative artificial intelligence (Gen AI), NLP (Natural Language Processing), large model, LLM (Large Language Model, large language model), deep learning, and the like.

### BACKGROUND

Artificial Intelligence (AI) finds implementations in different use cases in the context of data processing. In the field of AI, Generative AI (GAI) has recently seen an explosion in popularity. GAI includes AI models that generate a variety of content including, but not limited to, text, images, audio, and video based on training data. Examples of the AI models include Large Language Models (LLMs), which are a form of GAI that can be used to generate text for a variety of use cases. In some examples, LLMs can be integrated in digital assistants (e.g., chatbots) replacing traditional rule-based systems to provide responses to inputs received from a user. The rapid advancement of AI, particularly the emergence of large language models (LLMs), has ushered in a new era of technological innovation. These sophisticated LLM models are capable of understanding, interpreting, and generating human language with unprecedented accuracy and fluency, promising to revolutionize industries from healthcare to finance. However, to fully unlock the potential of LLMs, a robust infrastructure is required to manage, optimize, and coordinate their capabilities effectively.

### SUMMARY

Implementations of the present disclosure are generally directed to dynamic prompt orchestration. More particularly, implementations of the present disclosure are directed to a method and system of dynamic prompt orchestration is disclosed for providing context-driven adaptive user interaction using generative artificial intelligence (Gen AI), NLP (Natural Language Processing), large model, LLM (Large Language Model, large language model), deep learning, and the like.

As a particular example, a method is disclosed for maintaining a prompt library of artificial intelligence (AI) prompt categories, each of the prompt categories having individual prompts that are appropriate for different AI models in a model registry. The method may further include receiving an inquiry and selecting, from the prompt library, one of the prompt categories appropriate for advancing the received inquiry. Thereafter, the method may include selecting, based on the selected one of the prompt categories, an AI model from the model registry. A particular individual prompt may be selected from the selected one of the prompt categories, based on the selected AI model and submitted to the selected AI model. Moreover, the method may include receiving information identifying how to respond to the inquiry, from the selected AI model in response to the submitting. The received information may include at least one action and data supporting the at least one action. The method may further includes executing the at least one action based on the data and generating a response to the inquiry based on results of the executing.

The present disclosure further describes a system for implementing the method provided herein. The present disclosure also describes computer-readable storage media coupled to one or more processors and having instructions stored thereon which, when executed by the one or more processors, cause the one or more processors to perform operations in accordance with the method described herein.

It is appreciated that methods in accordance with the present disclosure can include any combination of the aspects and features described herein. That is, the method in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DRAWINGS

Various embodiments in accordance with the present disclosure will be described with reference to the drawings, in which:

FIG. 1 illustrates an example environment that may be used to execute implementations of the present disclosure.

FIG. 2 illustrates an example system architecture of dynamic prompt orchestration in accordance with implementations of the present disclosure.

FIG. 3 illustrates a block diagram that presents prompt orchestration module in accordance with implementations of the present disclosure.

FIG. 4 illustrates the flow diagram of an example method of dynamic prompt orchestration, in accordance with implementations of the present disclosure.

FIG. 5 illustrates a computer system that may be used to implement the system to provide context-driven adaptive user interaction in accordance with implementations of the present disclosure, in accordance with implementations of the present disclosure.

Like reference numbers and designations in the various drawings indicate like elements.

### DETAILED DESCRIPTION

In the following description, various embodiments will be illustrated by way of example and not by way of limitation in the figures of the accompanying drawings. References to various embodiments in this disclosure are not necessarily to the same embodiment, and such references mean at least one. While specific implementations and other details are discussed, it is to be understood that this is done for illustrative purposes only. A person skilled in the relevant art will recognize that other components and configurations may be used without departing from the scope of the claimed subject matter.

Reference to any “example” (e.g., “for example”, “an example of”, by way of example” or the like) are to be considered non-limiting examples regardless of whether expressly stated or not.

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only and is not intended to further limit the scope and meaning of the disclosure or of any exemplified term. Likewise, the disclosure is not limited to various embodiments given in this specification.

Without intent to limit the scope of the disclosure, examples of instruments, apparatus, methods, and their related results according to the embodiments of the present disclosure are given below. Note that titles or subtitles may be used in the examples for convenience of a reader, which in no way should limit the scope of the disclosure. Unless otherwise defined, technical and scientific terms used herein have the meaning as commonly understood by one of ordinary skill in the art to which this disclosure pertains. In the case of conflict, the present document, including definitions will control.

The term “comprising” when utilized means “including, but not necessarily limited to”; it specifically indicates open-ended inclusion or membership in the so-described combination, group, series and the like.

The term “a” means “one or more” unless the context clearly indicates a single element.

“First,” “second,” etc., are labels to distinguish components or blocks of otherwise similar names but does not imply any sequence or numerical limitation.

“And/or” for two possibilities means either or both of the stated possibilities (“A and/or B” covers A alone, B alone, or both A and B take together), and when present with three or more stated possibilities means any individual possibility alone, all possibilities taken together, or some combination of possibilities that is less than all of the possibilities. The language in the format “at least one of A . . . and N” where A through N are possibilities means “and/or” for the stated possibilities (e.g., at least one A, at least one N, at least one A and at least one N, etc.).

“Prompt” or the like refers to a submission to an AI model for processing.

“Prompt category” or the like refers to a collection of one or more prompts that are semantic variants of each other with substantive commonality. The variances may account for specific variance in AI models, such that any individual prompt is semantically designed to work better with a particular AI model for the best overall result from that prompt/model combination.

“Prompt preprocessing” refers to an automated methodology that receives a typed prompt and rewrites the prompt in real time.

It should also be noted that in some alternative implementations, the functions/acts noted may occur out of the order noted in the figures. For example, two steps disclosed or shown in succession may in fact be executed substantially concurrently or may sometimes be executed in the reverse order, depending upon the functionality/acts involved.

Specific details are provided in the following description to provide a thorough understanding of embodiments. However, it will be understood by one of ordinary skill in the art that embodiments may be practiced without these specific details. For example, systems may be shown in block diagrams so as not to obscure the embodiments in unnecessary detail. In other instances, well-known processes, structures, and techniques may be shown without unnecessary detail in order to avoid obscuring example embodiments.

The specification and drawings are to be regarded in an illustrative rather than a restrictive sense. It will, however, be evident that various modifications and changes may be made thereunto without departing from the broader spirit and scope of the invention as set forth in the claims.

For simplicity and illustrative purposes, the present disclosure is described by referring mainly to examples thereof. The examples of the present disclosure described herein may be used together in different combinations. The present disclosure further discloses a non-transitory computer readable medium storing instructions and a processor programmed to cooperate with the instructions in memory to perform operations. The method includes maintaining a prompt library of artificial intelligence (AI) prompt categories, each of the prompt categories having individual prompts that are appropriate for different AI models in a model registry. The method may further include first receiving an inquiry and first selecting, from the prompt library, one of the prompt categories appropriate for advancing the received inquiry. Thereafter, the method includes second selecting an AI model from the model registry, based on the selected one of the prompt categories. The method may also include third selecting a particular individual prompt from the selected one of the prompt categories, based on the selected AI model and submitted to the selected AI model. Moreover, the method includes receiving information identifying how to respond to the inquiry, from the selected AI model in response to the submitting. The received information may include at least one action and data supporting the at least one action. The method further includes executing the at least one action based on the data and generating a response to the inquiry based on results of the executing.

In other examples, the individual prompts within each of the prompt categories are semantic variations of each other, each of the semantic variations being optimized for a particular AI model within the model registry. The first selecting one of the prompt categories includes searching the prompt library for an appropriate prompt category or identifying an appropriate prompt category from a cache of prior inquiries and prompt categories selected in response to the prior inquiries. The maintaining a prompt library comprises establishing first criteria that define which individual prompts correspond to specific ones of the AI models in the AI registry and the secondly selecting is based on at least the first criteria. The second selecting is based on at least second criteria, including prioritization of inquiries with higher priority toward the AI models with shorter response times and/or higher accuracy rates, load balancing to distribute workload across the AI models, and/or performance of individual ones of the AI models and/or an overall system that executes the method. The maintaining a prompt library further includes receiving a prompt suggestion to incorporate into the prompt library, generating a prompt category corresponding to the prompt suggestion and generating individual prompts within the generated prompt category, the generated individual prompts matching at least some of the AI models in the AI model registry. Moreover, maintaining the prompt library includes refining the generated individual prompts followed by validating the generated individual prompt and the corresponding response. The method also includes versioning the generated individual prompts for tracking changes and adapting the generated individual prompts in real-time based on performance metrics. The method further includes continuously monitoring and evaluation of the performance of the prompts and administering and approving the prompts.

The dynamic prompt orchestration refers to managing and optimizing prompt-based interactions with AI models/language models. More specifically, the dynamic prompt orchestration engine that efficiently selects and sequences prompts to enhance the quality and efficiency of language model interactions. Large Language Model (LLM) applications are rapidly becoming essential in enterprise technology, driven by advances in models like GPT-4. As these applications grow more complex, they introduce unique challenges in performance measurement, debugging, and prompt optimization. Thus, the prompt management forms an integral part of modern LLM applications and there a need of prompt management practices that can enhance the functionality and effectiveness of LLM applications to provide context-driven adaptive user interaction.

The traditional methodologies of dynamic prompt orchestration to provide context-driven adaptive user interaction have technical problems. Historically, the entire process has been manual and requires extensive periods of time, and for which the research to find the answer falls within human subjectivity with different degrees of accuracy. Even automated methods, if using AI, have the technical problem of user dissatisfaction with the result of the AI inquiry, forcing a large number of prompt preprocessing->resubmission->review loops. This requires extensive user interaction and may never yield the most accurate results. Also, each resubmission loop carries its own power and processing requirements. As recognized in the AI art, AI submissions consume considerable amount of electricity and processing capacity. Continuous resubmission of prompts for revised inquiries thus becomes a collective power drain and resource drain. The number of AI submissions to an AI model can also have a contractual hard cap, and the continuous resubmission loops count against that cap and can prevent processing of other inquiries should the cap become exhausted.

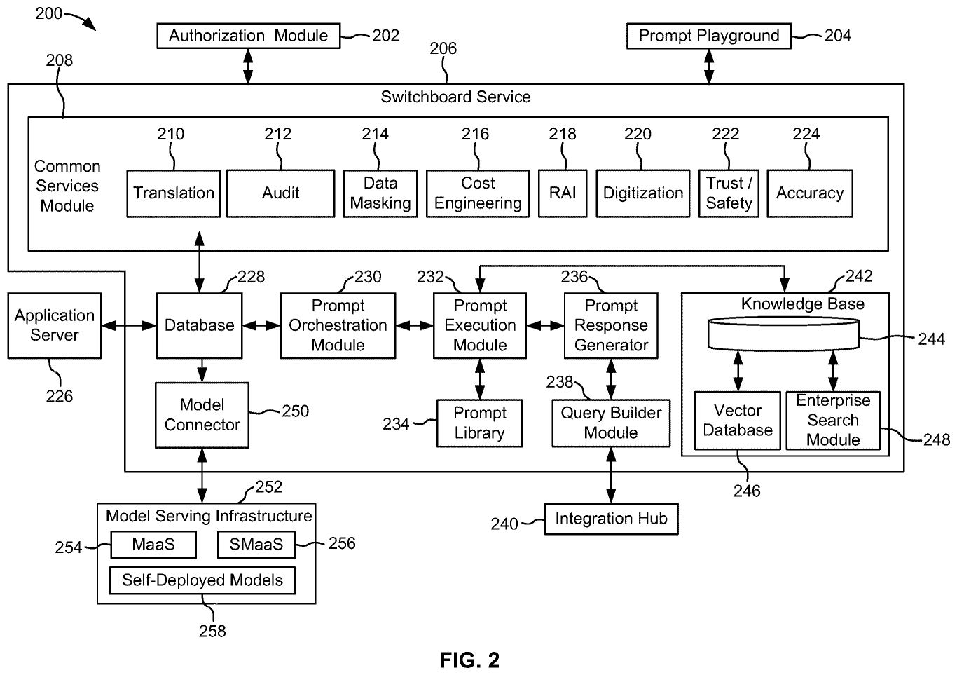

In view of this, implementations of the present disclosure provide a technical solution to the technical problems with traditional methods. The automated and AI aspects minimize human subjectivity in selection of avenues for research of answers to the inquiry. Traditional pre-processing of each inquiry to create a prompt is replaced by the faster and lower resource intensive reliance on finding pre-existing prompts from a prompt library 234 (Referring FIG. 2). Matching of the appropriate prompt with the appropriate AI model via the recited two step approach (use selected prompt category to select the AI model, then use the AI model to select a prompt within the selected prompt category) allows for the optimal best prompt/best AI model match, thereby providing more accurate responses and an associated reduction in resubmission loops, thus reducing response time, reliance on computer processing capacity, and overall power consumption, while minimizing the number of submissions relative to any hard cap.

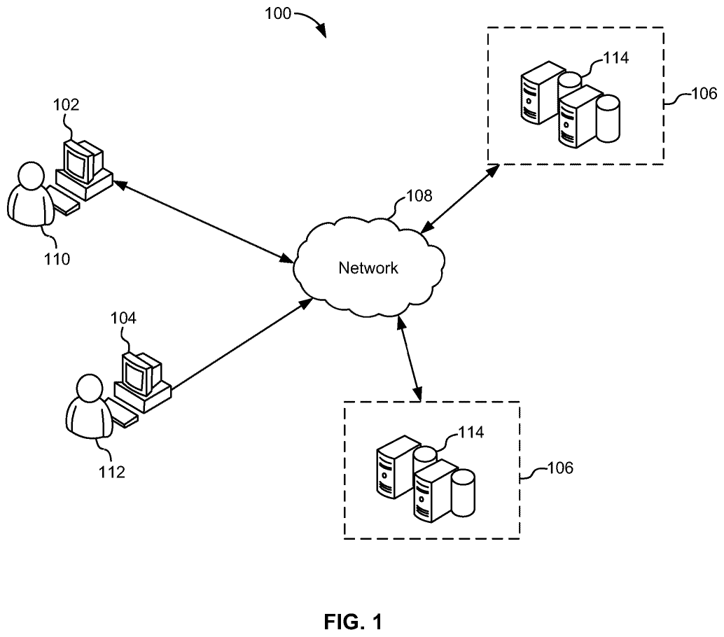

FIG. 1 depicts an example environment 100 that can be used to execute implementations of the present disclosure. In some examples, the example environment 100 enables users associated with respective systems to execute requests to generate content by invoking a trained language model in accordance with implementations of the present disclosure. The example environment 100 includes computing devices 102 and 104, back-end systems 106, and a network 110. In some examples, the computing devices 102 and 104 are used by respective users 114 and 116 to log into and interact with the platforms and running applications according to implementations of the present disclosure.

In the depicted example, the computing devices 102 and 104 are depicted as desktop computing devices. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing devices 102, 104), and back-end systems (e.g., the back-end systems 106). In some examples, the network 110 can be accessed over a wired and/or a wireless communications link. For example, mobile computing devices, such as smartphones can utilize a cellular network to access the network 110.

In the depicted example, the back-end systems 106 each include at least one server system 120. In some examples, the at least one server system 120 hosts one or more computer implemented services that users can interact with by using computing devices. For example, components of enterprise systems and applications can be hosted on one or more of the back-end systems 106. In some examples, a back-end system can be provided as an on-premises system that is operated by an enterprise or a third-party taking part in cross-platform interactions and data management. In some examples, a back-end system can be provided as an off-premises system (e.g., cloud or on-demand) that is operated by an enterprise or a third-party on behalf of an enterprise.

In some examples, the computing devices 102 and 104 each include computer 1 executable applications executed thereon. In some examples, the computing devices 102 and 104 each include a web browser application executed thereon, which can be used to display one or more web pages of platform running applications. In some examples, each of the computing devices 102 and 104 can display one or more GUIs that enable the respective users 114 and 116 to interact with the computing platform. In accordance with implementations of the present disclosure, the back-end systems 106 may host enterprise applications or systems that require data sharing and data privacy. In some examples, the computing device 102 and/or the computing device 104 can communicate with the back-end systems 106 over the network 110.

In some implementations, at least one of the back-end systems 106 can be implemented in a cloud environment that includes at least one server system 120. In the example of FIG. 1, the back-end server 106 can represent various forms of servers including, but not limited to, a web server, an application server, a proxy server, a network server, and/or a server pool. In general, server systems accept requests for application services and provide such services to any number of client devices (for example, the computing device 102 over the network 110).

In some implementations, the back-end system 106 can be used to implement an Artificial Intelligence (AI)-enabled platform trained to generate content relevant for individuals in accordance with contextual information and training data indicative of reactions of similar consenting individuals to certain content items (i.e., neuroscience responses). The AI-enabled platform can include a trained generative AI model that generates such personalized content. The generative AI model can be trained using a training corpus that combines data representing neuroscience responses of the individuals to stimuli triggered by various content items and corresponding context data acquired from a plurality of sources.

The techniques discussed in this specification enable artificial intelligence (AI) to be used to generate customized content, e.g., customized digital components, based on data related to a target audience for the customized content. In some implementations, technology described herein supports the ability to obtain input, create personalized content using a trained language model, and present the personalized content as output to be displayed on a display device of the user or system used for requesting the content, or directly provided for consumption by content platforms (e.g., as online content for web-platforms). The AI model as trained can generate customized content personalized for an individual or a group of individuals in a way that is expected to attract the individual or group of individuals to effectively engage with the generated content.

Various examples depicting dynamic prompt orchestration, are described in detail in conjunctions with figures below.

FIG. 2 illustrates an example system architecture 200 of dynamic prompt orchestration to provide context-driven adaptive user interaction, in accordance with implementations of the present disclosure. The system architecture 200 may include a switchboard service 206, an authorization module 202, a prompt playground 204, one or more application server 226, a model serving infrastructure 252 and an integration hub 240. Further, the switchboard service 206 may include a common services module 208, a database 228, a prompt orchestration module 230, a prompt execution module 232, a prompt response generator 236, a knowledgebase 242, a model connector 250, a query builder module 238, a prompt library 234.

The system architecture 200 may include a processor and a non-transitory memory storing instructions programmed to cooperate with the processor to perform operations, including receiving an inquiry and selecting, from the prompt library, one of the prompt categories appropriate for advancing the received inquiry. Thereafter, the system may include selecting, based on the selected one of the prompt categories, an AI model from the model registry. A particular individual prompt may be selected from the selected one of the prompt categories, based on the selected AI model and submitted to the selected AI model. Moreover, the system may include receiving information identifying how to respond to the inquiry, from the selected AI model in response to the submitting. The received information may include at least one action and data supporting the at least one action. The system may further includes executing the at least one action based on the data and generating a response to the inquiry based on results of the executing.

In further detail, the authorization module 202 may enable user authentication and authorization, thereby, ensuring secure access to the system. Specifically, the authorization module 202 may manage user permissions and access levels within the system and grant appropriate privileges to different users.

In some implementations, the prompt playground 204 enables users to build prompts using a set of prompt templates. For example, the prompt library 234 including prompt templates can be maintained, each prompt template providing a pattern that is specific to an AI model. In some examples, the prompt playground 204 enables users to experiment with prompts and compare the responses across multiple AI models. In this manner, users can consider the quality of responses and quantitatively determine cost and latency to use of respective AI models.

In some implementations, and as described in further detail herein, the one or more application server 226 each execute one or more applications that consume one or more AI models hosted in the model serving infrastructure 252. For example, an application can include a chatbot that provides responses generated by an AI model responsive to user input to the chatbot.

In some implementations, the model serving infrastructure 252 represents an environment, such as a cloud computing environment, within which the AI models are hosted. In some examples, the model serving infrastructure 252 can host the AI models in different types of paradigms, which can include, without limitation, model-as-a-service (MaaS) models 254, specialized MaaS (SMaaS) 256, and self-deployed models 258.

In some implementations, the model serving infrastructure 252 represents the technical infrastructure(s), in which the AI models are hosted. Example infrastructures include cloud computing platforms (e.g., Amazon Web Services (AWS), Google Cloud, Hugging Face, and on-premises solutions). In general, the switchboard service 206 submits inquiries to (e.g., through an API) and receives responses from one or more AI models executing within the model serving infrastructure 252. For example, the inquiry can include a prompt and an endpoint for an AI model that is to be queried using the prompt, and the response includes content (e.g., text) generated by the AI model. In some examples, a response is sent in response to an inquiry received by the switchboard service 206 from an application (e.g., executing on the applications server), and the response from the AI model is returned to the application.

The common services module 208 may provide functionalities to multiple parts of the system. The common services module 208 may provide core capabilities that are reused, thereby, enhancing efficiency, reducing redundancy, and ensuring consistency. The functionalities of the common services module 208 may include, but not limited to translation 210, audit 212, data masking 214, cost engineering 216, RAI (responsible AI) 218, digitization 220, trust & safety 222 and accuracy 224. Specifically, the translation 210 may include language translation capabilities for multilingual support. The audit 212 may include tracking system activities, user actions, and performance metrics for compliance, troubleshooting, and analysis. The data masking 214 may include protecting the sensitive data by obfuscating or replacing it with non-sensitive information. The cost engineering 216 may include optimizing resource utilization and cost management, ensuring efficient operation. The RAI 218 enforces ethical AI principles, ensuring fairness, transparency, and accountability. The digitization 220 may include converting physical documents or data into digital formats for processing. The trust and safety 222 may include implementing security measures to protect the system and data, thereby building user trust. The accuracy 224 may include maintaining data quality and ensuring accurate outputs.

The database 228 may store data from various sources. For example, the data sources may include, but not limited to, email connectors, ticket systems, chat connectors, web crawler, audio connector and user interface input. Specifically, the email connector may extract data from various email platforms (e.g., Outlook, Gmail, Exchange) including email content, sender/recipient information, subject lines, attachments, and metadata such as timestamps. The ticket system may extract data from ticketing platforms (e.g., Zendesk, Jira, ServiceNow) to retrieve ticket details, customer information, ticket status, and related correspondence. The chat connectors may extract data from chat platforms (e.g., Slack, Teams, WhatsApp) for extracting conversation history, user interactions, and relevant metadata. The web crawler may extract data from websites, including text content, images, and structured data. The audio connector may extract data from various sources like call recordings, voice messages, or audio files uploaded by users. The user interface input may be provided for direct user input, which can include text, images, or other forms of data.

The data ingested from various data sources into the database 228 can be processed and transformed into a usable format for further analysis or processing. The ingested data may be transformed though techniques like, but not limited to, textual analysis, natural language processing (NLP), audio processing and data enrichment. The textual analysis may include processing textual data (e.g., emails, chat messages) to extract keywords, entities, sentiment, and other relevant information. The NLP may provide context or semantic meaning of text data. Audio processing may include converting audio data into text format (transcription) using speech-to-text engines. The data enrichment may add context or additional information to the data (e.g., geolocation, demographic data).

Moreover, the prompt orchestration module 230 may manage the prompt selection, optimization, and execution based on user input. Specifically, the prompt orchestration module 230 can be responsible for managing and utilizing AI models and prompts to generate responses to user inquiries. Further, the prompt execution module 232 may execute selected prompts on AI models to generate text outputs. The prompt response generator 236 may generate standard response formats for consistency and clarity. Specifically, the prompt response generator 236 may configure responses using AI models, ensuring adaptability and experimentation. Further, the prompt response generator 236 may integrate with diverse systems like APIs, databases, and data lakes, or the like. The integration with APIs provides timely updates and customizable outputs and the integration with dynamic data lakes allows for holistic information utilization. The prompt response generator 236 efficiently integrates with prompt orchestration module 230, thereby ensuring unified workflows. Additionally, AI model based configurations and integrated database responses enhance adaptability, experimentation, and consistency, providing a comprehensive solution for intelligent and dynamic response generation from varied sources.

The query builder module 238 may generates queries for processing by AI models in the model serving infrastructure 252, thereby facilitating structured input and output.

The knowledge base 242 may provide access to external information to generate responses for input query. Furthermore, the prompt library 234 may store pre-defined prompts, templates, and examples used to interact with remote AI models. Specifically, the prompt library 234 may include a centralized repository for storing, organizing, and managing prompts, that are readily accessible for various applications and use cases. The prompt library 234 may provide a structured collection of prompts that can be efficiently accessed and utilized during the prompt generation and execution process. For example, the prompt library 234 may include golden template and custom prompt. The golden template may include set of optimized and refined prompts that serve as a foundation or baseline for other prompts. For example, the golden template may further include specific prompts or templates tailored for different helpdesk domains (e.g. human resources (HR), general inquiries, healthcare, and accounts payable etc.). The custom prompt may include prompts that can be created or modified by individual users or clients according to specific requirements. Additionally, the integration hub 240 may connect to external systems and data sources, thereby enabling data integration and interoperability.

The knowledge base 242 may provide access to structured and unstructured information required to generate response against received inquiry. The structured data may include Facts, figures, definitions, and other information that can be easily searched and retrieved. The unstructured data may include textual content, images, videos, and other forms of data that require more advanced processing and analysis. Specifically, the knowledge base 242 can be queried to retrieve information based on specific prompts. Moreover, the knowledge base 242 may further include a vector database 246 and an enterprise search module 248. The vector database 246 may store and search data represented in numerical form, known as vectors. The vector database 246 may store and manage data, such as text, images, and audio, by converting them into high-dimensional vector embeddings. The vector embeddings capture the semantic relationships between data, thereby enabling fast and efficient similarity searches. Further, the enterprise search module 248 may provide a unified search interface to access information from different sources within the organization. The enterprise search module 248 may further include indexing and searching across various data sources, such as documents, emails, databases, and more.

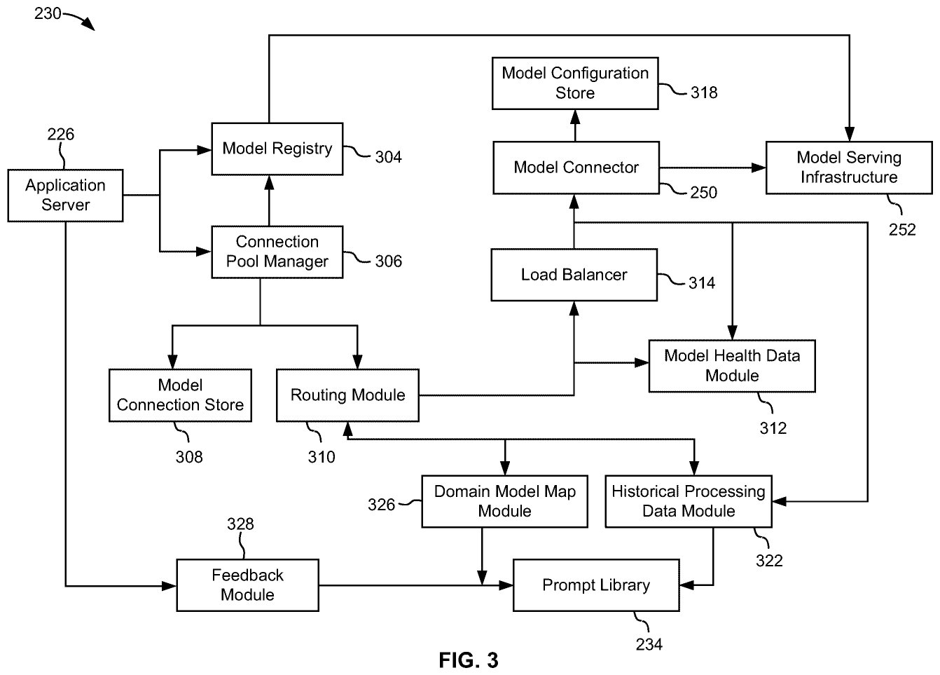

FIG. 3 illustrates a block diagram that presents the prompt orchestration module 230, in accordance with implementations of the present disclosure. The prompt orchestration module 230 may further include a model registry 304, a connection pool manager 306, a model connection store 308, a routing module 310, a model configuration store 318, the model connector 250, a load balancer 314, a model health data module 312, a domain model map module 326, a historical processing data module 322, a feedback module 328 and the prompt library 234.

In further detail, the application server 226 submits an inquiry (e.g., including a prompt) to the prompt orchestration module 230 (e.g., through the API). For example, the inquiry can include policy parameters (e.g., a tenant identifier (uniquely identifying a tenant operating the application server), an application identifier (uniquely identifying the application server), a domain, an intent, a task, and a modality) that define a policy that is to be applied to the query. More specifically, the prompt orchestration module 230 implements top-level functionality to handle application programming interface (API) requests to the switchboard service 206 (e.g., from applications executed on application server(s) 106) for comparing, routing, and the like, by orchestrating execution of a suite of granular services and functions.

Furthermore, the model registry 304 may include centralized repository that stores and manages available AI models. The model registry 304 may also store metadata such as model type (e.g., generative, discriminative), version (e.g., v1, v2), capabilities (e.g., text generation, translation, summarization), performance metrics (e.g., accuracy, latency), model size and resource requirements and training data and hyperparameters, thereby providing essential information about each AI model for effective selection and deployment. The metadata may be organized in a structured format (e.g., JSON, YAML) for efficient querying and retrieval. Moreover, the model registry 304 may implement application programming interface (API) for interacting with the model registry 304. Specifically, the model registry 304 may provide endpoints for registering new AI models and their corresponding metadata, updating existing AI model metadata, retrieving information about specific AI mode or search for AI models based on desired criteria and deleting AI model from the model registry 304.

In further detail, the AI models in the model registry 304 can be segmented/categorized based on specific criteria like, but not limited to, domain expertise, language proficiency, and communication style, thereby effectively routing prompts to the most suitable AI model and improving overall performance and efficiency. For instance, different domains require specialized knowledge and language patterns. By categorizing AI models based on their domain expertise, the system can ensure that prompts related to specific domains are routed to the most knowledgeable AI model. For example, a healthcare AI model would be better equipped to answer medical queries than a general-purpose AI model. In another instance, language is a complex aspect of communication. Categorizing AI model based on their language proficiency allows the system to accurately match prompts with AI models that can effectively process and generate text in the desired language. For example, a Spanish AI model would be the ideal choice for a Spanish language query. In another instance, different communication styles require different linguistic context and tones. By categorizing AI model based on their communication style, the system can ensure that the generated text aligns with the desired context and tone. For example, a formal legal AI model would be better suited for generating legal documents, while a general-purpose AI model might be more appropriate for social media content.

The model connector 250 may establish and manage connections to various AI model of the model serving infrastructure 252 based on runtime configurations. More specifically, the model connector 250 establishes connections to AI models in model serving infrastructure 252 by retrieving connection parameters from a configuration file or database, thereby allowing for flexible integration of different AI models in the model serving infrastructure 252 without requiring code modifications. Further, the model connector 250 may implement dynamic loading techniques such as reflection or plugin architecture, to load and instantiate model-specific libraries or modules at runtime, thereby enabling the integration of new AI models without requiring recompilation or redeployment.

The model configuration store 318 may manage, and store configuration details related to AI models. Specifically, the model configuration store 318 may include a central repository for model connection parameters, enabling dynamic updates without requiring system restarts. The model configuration store 318 may ensure that model configurations can be modified and updated without disrupting the overall system operation. The model configuration store 318 may further include mechanisms to track changes, validate new configurations, and propagate updates to relevant components. Additionally, data can be stored centrally in a database or distributed across multiple key-value stores.

The connection pool manager 306 may establish and manage connections to AI models in the model registry 304. Specifically, the connection pool manager 306 may create and maintain a collection of established connections to AI models. The connection pool manager 306 may create and manage a pool of idle connections to AI models and allocate connections from the pool to incoming inquiries. Further, the connection pool manager 306 may return the connections to the pool upon completion of tasks and monitors connection health and removes inactive or invalid connections. Furthermore, the connection pool manager 306 may implement algorithms and data structures to distribute incoming inquiries across the pool of connections effectively, thereby ensuring optimal utilization of resources and prevents overloading individual AI models.

The model connection store 308 stores details about established connections to different AI models, including connection parameters, status, and potentially performance metrics. The model connection store 308 is responsible for managing and maintaining active connections to the various AI models integrated into the system. Moreover, the model connection store 308 keeps track of which models are currently being used, their availability status, and the specific connections established with them. Specifically, the model connection store 308 may monitors the status of each connection, such as whether it's active, idle, or disconnected. Further, the model connection store 308 may reuse existing connections instead of creating new ones for every received inquiry, thereby, reducing overhead and improving performance. In case of multiple incoming inquiries or limited AI model resources, the model connection store 308 may prioritize connections based on factors like model performance, response time, or workload.

The routing module 310 may dynamically select the optimal AI model for a given inquiry. The selection of optimal AI model can be based on model performance metrics, task requirements and user preferences. The model performance metrics may include quantitative measures of AI model, such as accuracy, fluency, coherence, and relevance. The task requirements may include specific attributes of the inquiry, such as language, domain, length, and desired output format. The user preference may include individual user-defined criteria, such as speed, cost, or the like. The dynamic selection may include utilization of the machine learning algorithms and/or rule-based strategies. The machine learning algorithms may further include statistical models trained on historical data to learn complex patterns and relationships between input inquiries, model performance, and user preferences. The rule-based strategies may include predefined set of rules and conditions to determine optimal AI model selection based on specific input inquiries and predefined thresholds. Essentially, the routing module may route the received inquiries to the most suitable/optimal AI model based on real-time data and learned patterns.

The load balancer 314 may distributing incoming prompts or requests across multiple AI models, thereby ensuring optimal utilization of available resources, preventing bottlenecks, and enhancing overall system performance. Specifically, the load balancer 314 may utilize load balancing techniques like, but not limited to, round-robin routing, dynamic load balancing and priority-based load balancing. The round-robin routing may include distributing prompts sequentially among available AI models to ensure fair allocation of tasks. The dynamic load balancing may include continuously monitoring the performance of AI model and adjusting the distribution of prompts accordingly. The priority-based load balancing may include assigning priorities to AI model based on criteria like processing speed, accuracy, or cost. High-priority AI model may receive more prompts, ensuring that critical tasks are handled efficiently.

The model health data module 312 may identify and mitigate issues related to the performance and availability of AI models. Specifically, the model health data module 312 may implement a combination of quantitative and qualitative monitoring techniques to continuously assess the health and performance metrics of deployed AI models. The monitoring techniques may include performance metrics collection, anomaly detection, root cause analysis. The performance metrics collection may include continuously collecting key performance indicators (KPIs) such as latency, throughput, error rates, and accuracy metrics. The anomaly detection may include statistical methods or machine learning algorithms to identify deviations from expected performance patterns. The root cause analysis may include investigating the underlying causes of performance issues, such as data quality problems, model degradation, or infrastructure failures. Moreover, the model health data module 312 may configure automatic failover and fallback strategies to ensure uninterrupted service availability. For example, the model health data module 312 may enable automatic switch to backup AI models or alternative processing paths in case of primary AI model failure. In another example, the model health data module 312 may provide default or degraded service options to maintain basic functionality during critical failures. Essentially, the model health data module 312 may enable the system to detect, respond to, and recover from issues, ultimately ensuring a high level of service availability and performance.

Moreover, the feedback module 328 may implement a feedback mechanism where users can provide feedback on the quality of responses received, thereby improving routing decisions and optimize performance over time.

Specific details are provided in the following description to provide a thorough understanding of data flow in prompt orchestration module 230 to provide context-driven adaptive user interaction, in accordance with implementations of the present disclosure.

A set of pre-defined artificial intelligence (AI) prompt categories can be maintained in the prompt library 234. Specifically, the prompt library 234 may store various prompt categories, each prompt category including individual prompts optimized for different AI models in the model registry 304. Specifically, the individual prompts within each of the prompt categories are semantic variations of each other, each of the semantic variations being optimized for a particular AI model within the model registry 304. The inquiry may be received from the application server 226. Thereafter, one of the prompt categories appropriate for advancing the received inquiry may be selected from the prompt library 234. Herein, the prompt categories refer to set of prompts that are utilized to identify the context of the received inquiry. Specifically, the routing module 310, in conjunction with the domain model map module 326 and historical processing data module 322, may select an appropriate prompt category based on the received inquiry. The domain model map module 326 may enable the mapping of received inquiries to relevant AI models and prompt categories. Further, the historical processing data module 322 may store data of past interactions to improve future recommendations. The routing module 310 may search the prompt library 234 for an appropriate prompt category and identify the appropriate prompt category from a cache of prior inquiries and prompt categories selected in response to the prior inquiries.

In further detail, based on the inquiry received, a prompt suggestion may be received to incorporate into the prompt library 234. A prompt category corresponding to the prompt suggestion may generate followed by generation of individual prompts within the generated prompt category. Herein, the generated individual prompts may match at least some of the AI models in the model registry 304. Furthermore, the generated individual prompt and the corresponding response may be validated. Specifically, the prompt and its corresponding response can be evaluated for profanity or any inappropriate content, thereby ensuring that the prompt aligns with ethical and quality standards. The generated individual prompt may adapt in real-time based on performance metrics. Specifically, the generated individual prompts may be dynamically adjusted based on real-time feedback or performance metrics, thereby providing continuous improvement. Moreover, the generated individual prompt may be versioned for tracking changes and maintaining historical records. Consequently, the generated individual prompts may store in a central repository.

In an example, the AI prompt categories may include, but not limited to, product inquiry (e.g. prompts related to product features, specifications, pricing, etc.), order and shipping (e.g. prompts related to order status, shipping details, returns, etc.), technical issues (e.g. prompts related to product malfunctions, software errors, etc.) and account management (e.g. prompts related to account creation, password reset, billing, etc.). For an instance, an inquiry “What is the status of invoice number 3425” is received from a help desk application, for example, Servicenow. The received inquiry can be analyzed and compared against the prompts in each category of the prompt library 234 to determine the context. Based on the best match, the inquiry can be categorized as the “order and shipping” category.

Furthermore, the routing module 310 may select optimal AI model from the model registry 304, based on selected prompt categories. Specifically, the selection of optimal AI model from the model registry 304 may utilize one or more criteria. The one or more criteria may include prioritization of inquiries with higher priority toward the AI models with shorter response times and/or higher accuracy rates, load balancing to distribute workload across the AI models and/or performance of individual ones of the AI models and/or an overall system that executes the method. The load balancer 314 may distribute received inquiries across available AI models in the model registry 304 to ensure optimal performance and prevent overloading.

Thereafter, the routing module 310 may select a particular individual prompt from the selected one of the prompt categories based on the selected AI model. The model connector 250 may submit the selected particular individual prompt to the selected AI model. The model connector 250 may further receive the response of the AI model, wherein the response may include information on how to respond to the inquiry. Moreover, the information may include at least one action and data supporting the at least one action. The connection pool manager 306 may establish and manage the connection to the AI model and execute the actions required based on the received information. Subsequently, the routing module 310 may process the response and generate a final response to the user based on the received information and system knowledge.

In an example, a user submits an inquiry about their order status through an application, for example customer service portal or chatbot. The inquiry is received by the prompt orchestration module 230 via the database 228. Thereafter, the routing module 310 searches the prompt library 234 and analyzes the received inquiry. The routing module 310 determines that the received inquiry falls under the “order status” prompt category. Based on factors like historical performance, current load, and response time, the routing module selects an AI model specialized in order tracking from the model registry 304. Furthermore, a prompt is selected from the prompt library 234 specifically designed for order status inquiries and the selected AI model. The retrieved prompt might include placeholders for order number, customer ID, and other relevant information. The model connector 250 routes the selected prompt to the selected AI model in the model registry 304. The AI model processes the inquiry and returns a response containing information about the order status, shipping details, and potential next steps. The returned response is received by the model connector 250. If the response indicates that the order is delayed, the system might trigger an action including sending a notification to the customer or escalating the issue to customer support. The action would be executed by the connection pool manager 306. Consequently, the AI model's response is formatted into a user-friendly format and presents the response to the customer.

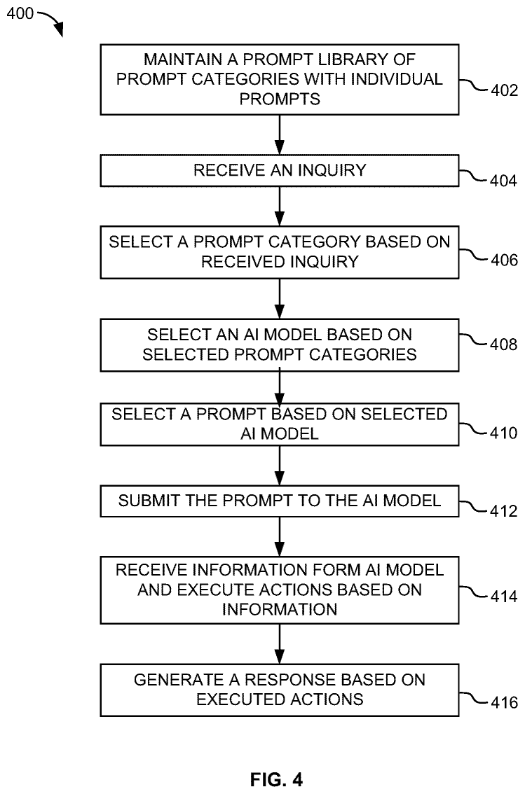

FIG. 4 illustrates the flow diagram of an example method 400 for providing context-driven adaptive user interaction, in accordance with implementations of the present disclosure. In some implementations, the method 400 may be executed within the system for providing context-driven adaptive user interaction, as described in relation to FIG. 2 and FIG. 3.

At step 402, the method 400 includes maintaining the prompt library 234 of artificial intelligence (AI) prompt categories, each of the prompt categories having individual prompts that are appropriate for different AI models in a model registry 304. The individual prompts within each of the prompt categories are semantic variations of each other, each of the semantic variations being optimized for a particular AI model within the model registry 304.

At step 404, the method 400 includes first receiving an inquiry. For example, the inquiry can be received by user via application server 226 and stored in database 228, for further processing and analysis.

At step 406, the method 400 includes first selecting from the prompt library 234, one of the prompt categories appropriate for advancing the received inquiry. Specifically, the routing module 310, in conjunction with domain model map module 326 and historical processing data module 322, searches the prompt library 234 and determine the prompt category under which the received inquiry falls. This may include searching the prompt library for an appropriate prompt category or identifying an appropriate prompt category from a cache of prior inquiries and prompt categories selected in response to the prior inquiries.

At step 408, the method 400 includes second selecting, based on the selected one of the prompt categories, an AI model from the model registry 304. Specifically, based on the determined prompt category, the routing module 310 selects the best suited AI model. Furthermore, the routing module 310 utilizes one or more criteria to select the AI model from the model registry 304. The one or more criteria may include prioritization of inquiries with higher priority toward the AI models with shorter response times and/or higher accuracy rates, load balancing to distribute workload across the AI models and/or performance of individual ones of the AI models and/or an overall system that executes the method.

At step 410, the method 400 includes third selecting, based on the selected AI model, a particular individual prompt from the selected one of the prompt categories. Specifically, the routing module 310 selects a particular prompt from the selected prompt category.

At step 412, the method 400 includes, submitting the selected particular individual prompt to the selected AI model, by the model connector 250.

At step 414, the method 400 includes, second receiving, from the selected AI model in response to the submitting, information identifying how to respond to the inquiry, the information including at least one action and data supporting the at least one action. Specifically, the model connector 250 receives the response generated by the AI model.

At step 416, the method 400 includes, executing the at least one action based on the data. Specifically, the connection pool manager 306 may establish and manage the connection to the AI model and execute the actions.

At step 418, the method 400 includes, generating a response to the inquiry based on results of the executing. Specifically, the routing module 310 process the response and generate a final response.

Implementations of the present disclosure provide a technical solution to the technical problems with traditional methods. The automated and AI aspects minimize human subjectivity in selection of avenues for research of answers to the inquiry. Traditional pre-processing of each inquiry to create a prompt is replaced by the faster and lower resource intensive reliance on finding pre-existing prompts from the prompt library 234. Matching of the appropriate prompt with the appropriate AI model via the recited two step approach (use selected prompt category to select the AI model, then use the AI model to select a prompt within the selected prompt category) allows for the optimal best prompt/best AI model match, thereby providing more accurate responses and an associated reduction in resubmission loops, thus reducing response time, reliance on computer processing capacity, and overall power consumption, while minimizing the number of submissions relative to any hard cap.

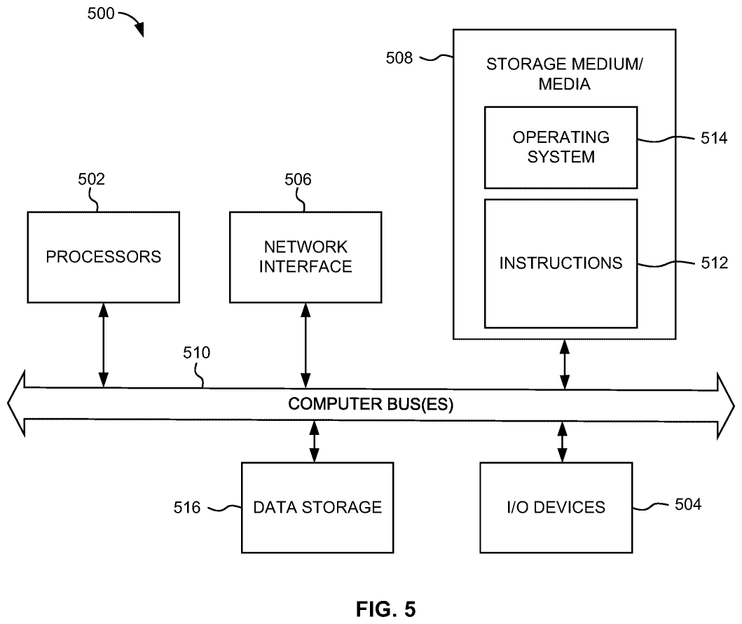

FIG. 5 illustrates a computer system 500 that may be used to implement the dynamic prompt orchestration. More particularly, computing machines such as desktops, laptops, smartphones, tablets, and wearables which may be used to select the foundation models 116a-116n for the tasks that may have the structure of the computer system 500. The computer system 500 may include additional components not shown and that some of the process components described may be removed and/or modified. In another example, a computer system 500 may be deployed on external-cloud platforms such as cloud, internal corporate cloud computing clusters, organizational computing resources, and/or the like.

The computer system 500 includes processor(s) 502, such as a central processing unit, application-specific integrated circuit (ASIC) or another type of processing circuit, input/output devices 504, such as a display, mouse keyboard, etc., a network interface 506, such as a Local Area Network (LAN), a wireless 802.11x LAN, a 3G or 4G mobile WAN or a WiMax WAN, and a computer-readable medium 508. Each of these components may be operatively coupled to a bus 510. The computer-readable medium 508 may be any suitable medium that participates in providing instructions to the processor(s) 502 for execution. For example, the computer-readable medium 508 may be non-transitory or non-volatile medium, such as a magnetic disk or solid-state non-volatile memory or volatile medium such as random access memory (RAM). The instructions or modules stored on the computer-readable medium 508 may include machine-readable instructions 512 executed by the processor(s) 502 that cause the processor(s) 502 to perform the methods and functions of the dynamic prompt orchestration.

The dynamic prompt orchestration may be implemented as software stored on a non-transitory processor-readable medium and executed by the processors 502. For example, the computer-readable medium 508 may store an operating system 514, such as MAC OS, MS WINDOWS, UNIX, or LINUX, and code for the dynamic prompt orchestration. The operating system 514 may be multi-user, multiprocessing, multitasking, multithreading, real-time, and the like. For example, during runtime, the operating system 514 is running and the code for the dynamic prompt orchestration is executed by the processor(s) 502.

The computer system 500 may include a data storage 516, which may include non-volatile data storage. The data storage 516 stores any data used or generated by the dynamic prompt orchestration.

The network interface 506 connects the computer system 500 to internal systems for example, via a LAN. Also, the network interface 506 may connect the computer system 500 to the Internet. For example, the computer system 500 may connect to web browsers and other external applications and systems via the network interface 506.

What has been described and illustrated herein is an example along with some of its variations. The terms, descriptions, and figures used herein are set forth by way of illustration only and are not meant as limitations. Many variations are possible within the spirit and scope of the subject matter, which is intended to be defined by the following claims and their equivalents.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products (i.e., one or more modules of computer program instructions encoded on a computer readable medium for execution by, or to control the operation of, data processing apparatus). The computer readable medium may be a machine-readable storage device, a machine-readable storage substrate, a memory device, a composition of matter effecting a machine-readable propagated signal, or a combination of one or more of them. The term computing system encompasses all apparatus, devices, and machines for processing data, including by way of example a programmable processor, a computer, or multiple processors or computers. The apparatus may include, in addition to hardware, code that creates an execution environment for the computer program in question (e.g., code that constitutes processor firmware, a protocol stack, a database management system, an operating system, or any appropriate combination of one or more thereof). A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display) monitor) for displaying information to the user and a keyboard and a pointing device (e.g., a mouse, a trackball, a touch-pad), by which the user may provide input to the computer. Other kinds of devices may be used to provide for interaction with a user as well; for example, feedback provided to the user may be any appropriate form of sensory feedback (e.g., visual feedback, auditory feedback, tactile feedback); and input from the user may be received in any appropriate form, including acoustic, speech, or tactile input.

Implementations may be realized in a computing system that includes a back end component (e.g., as a data server), a middleware component (e.g., an application server), and/or a front end component (e.g., a client computer having a graphical user interface or a Web browser, through which a user may interact with an implementation), or any appropriate combination of one or more such back end, middleware, or front end components. The components of the system may be interconnected by any appropriate form or medium of digital data communication (e.g., a communication network). Examples of communication networks include a local area network (LAN) and a wide area network (WAN), e.g., the Internet.

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims.

What is claimed is:

1. A method, comprising:
maintaining a prompt library of artificial intelligence (AI) prompt categories, each of the prompt categories having individual prompts that are appropriate for different AI models in a model registry;
first receiving an inquiry;
first selecting, from the prompt library, one of the prompt categories appropriate for advancing the received inquiry;
second selecting, based on the selected one of the prompt categories, an AI model from the model registry;
third selecting, based on the selected AI model, a particular individual prompt from the selected one of the prompt categories;
submitting the selected particular individual prompt to the selected AI model;
second receiving, from the selected AI model in response to the submitting, information identifying how to respond to the inquiry, the information including at least one action and data supporting the at least one action;
executing the at least one action based on the data; and
generating a response to the inquiry based on results of the executing.

2. The method of claim 1, wherein the individual prompts within each of the prompt categories are semantic variations of each other, each of the semantic variations being optimized for a particular AI model within the model registry.

3. The method of claim 1, the first selecting comprises:
searching the prompt library for an appropriate prompt category; or
identifying an appropriate prompt category from a cache of prior inquiries and prompt categories selected in response to the prior inquiries.

4. The method of claim 1, further comprising:
the maintaining a prompt library comprises establishing first criteria that define which individual prompts correspond to specific ones of the AI models in the model registry; and
the second selecting is based on at least the first criteria.

5. The method of claim 4, further comprising:
the second selecting is based on at least second criteria, including:
prioritization of inquiries with higher priority toward the AI models with shorter response times and/or higher accuracy rates;
load balancing to distribute workload across the AI models; and/or
performance of individual ones of the AI models and/or an overall system that executes the method.

6. The method of claim 1, the maintaining a prompt library further comprising:
receiving a prompt suggestion to incorporate into the prompt library;
generating a prompt category corresponding to the prompt suggestion; and
generating individual prompts within the generated prompt category, the generated individual prompts matching at least some of the AI models in the AI model registry.

7. The method of claim 6, the maintaining a prompt library further comprising:
validating the generated individual prompt and the corresponding response;
adapting the generated individual prompts in real-time based on performance metrics;
versioning the generated individual prompts for tracking changes; and
storing the generated individual prompts in a central repository.

8. A non-transitory computer readable medium storing instructions programmed to cooperate with electronic computer hardware in combination with software to perform operations, comprising:
maintaining a prompt library of artificial intelligence (“AI”) prompt categories, each of the prompt categories having individual prompts that are appropriate for different AI models in a model registry;
first receiving an inquiry;
first selecting, from the prompt library, one of the prompt categories appropriate for advancing the received inquiry;
second selecting, based on the selected one of the prompt categories, an AI model from the model registry;
third selecting, based on the selected AI model, a particular individual prompt from the selected one of the prompt categories;
submitting the selected particular individual prompt to the selected AI model;
second receiving, from the selected AI model in response to the submitting, information identifying how to respond to the inquiry, the information including at least one action and data supporting the at least one action;
executing the at least one action based on the data; and
generating a response to the inquiry based on results of the executing.

9. The non-transitory computer readable medium of claim 8, wherein the individual prompts within each of the prompt categories are semantic variations of each other, each of the semantic variations being optimized for a particular AI model within the model registry.

10. The non-transitory computer readable medium of claim 8, the first selecting comprises:
searching the prompt library for an appropriate prompt category; or
identifying an appropriate prompt category from a cache of prior inquiries and prompt categories selected in response to the prior inquiries.

11. The non-transitory computer readable medium of claim 7, the operations further comprising:
the maintaining a prompt library comprises establishing first criteria that define which individual prompts correspond to specific ones of the AI models in the AI registry; and
the second selecting is based on at least the first criteria.

12. The non-transitory computer readable medium of claim 11, the operations further comprising:
the second selecting is based on at least second criteria, including:
prioritization of inquiries with higher priority toward the AI models with shorter response times and/or higher accuracy rates;
load balancing to distribute workload across the AI models; and/or
performance of individual ones of the AI models and/or an overall system that executes the operations.

13. The non-transitory computer readable medium of claim 8, the maintaining a prompt library further comprising:
receive a prompt suggestion to incorporate into the prompt library;
generate a prompt category corresponding to the prompt suggestion; and
generate individual prompts within the generated prompt category, the generated individual prompts matching at least some of the AI models in the AI model registry.

14. The non-transitory computer readable medium of claim 13, the maintaining a prompt library further comprising:
validating the generated individual prompt and the corresponding response;
adapting the generated individual prompts in real-time based on performance metrics;
versioning the generated individual prompts for tracking changes; and
storing the generated individual prompts in a central repository.

15. A system, comprising:
a processor;
a non-transitory memory storing instructions programmed to cooperate with the processor to perform operations, comprising:
maintaining a prompt library of artificial intelligence (“AI”) prompt categories, each of the prompt categories having individual prompts that are appropriate for different AI models in a model registry;
first receiving an inquiry;
first selecting, from the prompt library, one of the prompt categories appropriate for advancing the received inquiry;
second selecting, based on the selected one of the prompt categories, an AI model from the model registry;
third selecting, based on the selected AI model, a particular individual prompt from the selected one of the prompt categories;
submitting the selected particular individual prompt to the selected AI model;
second receiving, from the selected AI model in response to the submitting, information identifying how to respond to the inquiry, the information including at least one action and data supporting the at least one action;
executing the at least one action based on the data; and
generating a response to the inquiry based on results of the executing.

16. The system of claim 15, wherein the individual prompts within each of the prompt categories are semantic variations of each other, each of the semantic variations being optimized for a particular AI model within the model registry.

17. The system of claim 15, the first selecting comprises:
searching the prompt library for an appropriate prompt category; or
identifying an appropriate prompt category from a cache of prior inquiries and prompt categories selected in response to the prior inquiries.

18. The system of claim 15, the operations further comprising:
the maintaining a prompt library comprises establishing first criteria that define which individual prompts correspond to specific ones of the AI models in the AI registry; and
the second selecting is based on at least the first criteria.

19. The system of claim 18, the operations further comprising:
the second selecting is based on at least second criteria, including:
prioritization of inquiries with higher priority toward the AI models with shorter response times and/or higher accuracy rates;
load balancing to distribute workload across the AI models; and/or
performance of individual ones of the AI models and/or the system.

20. The system of claim 15, the maintaining a prompt library further comprising:
receive a prompt suggestion to incorporate into the prompt library;
generate a prompt category corresponding to the prompt suggestion; and
generate individual prompts within the generated prompt category, the generated individual prompts matching at least some of the AI models in the AI model registry.
